(19) United States
(12) Patent Application Publication
(10) Pub. No.: US 2008/0046330 A1
(43) Pub. Date: Feb. 21, 2008

(54) Method for an online community of a purchasing management system

(76) Inventors: Louay Daoud, Okemos, MI (US); Herad Azhar, New York, NY (US); Roger Noakes, New York, NY (US)

Correspondence Address: Rashida A. Karmali, 13th Floor, 99 Wall Street, New York, NY, 10005, US

(21) Appl. No.: 11/506,074

(22) Filed: Aug. 16, 2006

(51) Int. Cl. G06Q 30/00

(52) U.S. Cl. 705/26

(57) ABSTRACT

The invention provides a Purchasing Management System to an online Web site called YOURSHORTCUT.COM™, the system comprising a transactional database of registered consumers and vendors for organizing purchasing transactions by a buyer from multiple vendors into a database for reporting, analysis and business process control. The system's transactional database further comprises a software program to facilitate purchasing management decisions, reporting and process control. YOURSHORTCUT.COM uses the invention in an online consumer member portal with a business model that leverages low pricing from online vendors and provides the consumers with free e-mail accounts that are used for order confirmation.

### 1. FIELD OF INVENTION

A portion of the disclosure of this specification contains material which is subject to copyright protection. The copyright owner has no objection to the xerographic reproduction of the patent specification or disclosure, as it appears in the Patent and Trademark Office file wrapper, but otherwise reserves all copyright rights whatsoever. 37 C.F.R. Sec 1.72(e).

The present invention relates generally to an online community purchasing management system called YOURSHORTCUT.COM™, the system comprising a transactional database of registered consumers and vendors for organizing purchasing transactions by a buyer from multiple vendors into a database for reporting, analysis and business process control. The system's transactional database further comprises a software program to facilitate purchasing management decisions, reporting and process control. YOURSHORTCUT.COM uses the invention in an online consumer member portal with a business model that leverages low pricing from online vendors and provides the consumers with free e-mail accounts that are used for order confirmation.

### 2. BACKGROUND TO THE INVENTION

Electronic transactions involving the purchase of various goods and services have increased significantly with the use of public electronic environments and computer networks. To date, the biggest participants in such electronic transactions for goods are large businesses that typically make volume purchases. These types of companies tend to negotiate price discounts with one or more sellers of goods to negotiate entitled prices. The information needed to calculate the entitled price and the estimated delivery date and other such information is stored in a private electronic environment or a secure computer network. However, the individual user who is interested in making small purchases has no access to the competitive pricing process to negotiate a bargain or reasonable competitive price.

There are four main ways consumers and marketers can find relevant online information on vendor/competitors' product strengths and weaknesses and summary comments and overall performance rating of a product, supplier or vendor. These include independent customer goods and service review forums, distributor or sales agent feedback sites, combo-sites offering customer reviews and expert opinions, and customer complaints sites. The independent customer goods and service review forums include well known Web sites such as Epinions.com, Rateital.com, Consumerreview.com and Bizrate.com. Of these, the bizrate.com is probably the most sophisticated and user friendly.

Another drawback in the current electronic commerce is security concerns. While sellers face problems in qualifying buyers and verifying the legitimacy of orders, buyers are nervous about submitting credit card numbers over public networks and providing information that may be used to profile their purchasing patterns. Web access providers have developed means of assuring data integrity through use of electronic data interchange (EDI) which is used by large companies for the automated exchange of transaction data among suppliers, their customers and banks. Additionally, value-added networks (VANs) are used for EDI data interchange and provide greater security but these are costly and small vendors or consumers cannot afford the service costs.

This is because the website is constricted by the fact that it provides in depth information on goods and services for large companies and in a global margin but does not tailor the information on competing vendors at the community level in the community that the consumer resides in. There is therefore a need for a way to provide the individual shopper or consumer a higher bargaining power through customized community purchasing management systems. This invention relates to providing a method for an online community with a purchasing management system for the individual consumers. Additionally, the invention could be used by any purchasing entity or group wishing to optimize purchasing from a plurality of vendors with online (World Wide Web) commerce websites.

### 3. SUMMARY OF THE INVENTION

Briefly, the present invention satisfies the need for creating an online community of consumers and vendors, and a purchasing management system that facilitates purchases by a consumer from a range of vendors to optimize the consumer's purchasing activities based on a range of criteria including, but not limited to pricing, availability or quality.

In accordance with the above, it is an object of the invention to provide a purchasing management system based on a transactional database of historical purchases by registered consumers from vendors in the community. The contents of the transactional database are used for purposes of reporting, analyzing controlling the business process. Registration of consumers and vendors is a requirement for participation in the YOURSHORTCUT.COM business portal.

The present invention provides in a first aspect a method of placing an online order by the consumer at the online e-commerce website of the vendor, obtaining a bargained price and receiving a delivery date. This transactional data from the e-mail confirmations is stored in a transactional database. A software program applied to the transactional database queries the data collected and provides the necessary purchasing management decision, support, reporting and process control.

In another aspect of the present invention the Web site YOURSHORTCUT.COM uses the Purchasing Management System in an online consumer member portal with a business model that bargains and leverages low pricing from online vendors. The invention automatically provides email accounts free of charge to registered consumers. Said email assignment serves as the default address for consumers to confirm purchase orders and order status from specific vendors in the community while at the same time registering the transaction confirmation in the master transaction database in YOURSHORTCUT.COM. As a result consumer incentives are disbursed to consumers accordingly.

The invention also provides to the consumer a centralized history of shopping done in the community and YOURSHORTCUT.COM provides the consumer with options and advertisements that are designed to the consumer's preferences. In this regard, the invention also provides to the vendors the option of live active bidding for specific advertisement space on YOURSHORTCUT.COM

In yet another aspect of the invention the Web site YOURSHORTCUT.COM registers the vendors upon payment of a fee, to become part of the YOURSHORTCUT.COM business portal.

In yet another aspect of the present invention provides a system comprising a customer master database, a vendor master database and a transactional database that can be disseminated into an item master database for complete Enterprise Resource Planning (ERP) compatibility. The fine granularity of the data being at the one buyer, one vendor and one item level provides for unlimited combinations of reporting, analysis, management and process control by customers, administrators or managers.

Another embodiment of the invention provides vendors data suitable for controls that are driven by the data collected in the transactional database to determine minimum inventory levels, just in time supply, parts and finished goods inventory management. The invention additionally generates the potential for a wide range of automated purchasing systems from the data.

These and other objects of the present invention will become clearer from the following detailed description of the preferred embodiments, particularly when read in conjunction with the drawings which form a part of the specification.

### 4. BRIEF DESCRIPTION OF THE DRAWINGS

For a fuller understanding of the invention, reference is made to the following description, taken in connection with the accompanying drawings, in which:

FIG. 1 is a block diagram that shows the basic modules of the YOURSHORTCUT.COM purchase management system, including the customer registration module (10), the vendor registration module (11), the transaction database module (12), the e-mail server (13) and the e-mail data extraction module (14).

FIG. 2 is a flow diagram that describes the organization of the customer registration module (10) in terms of the steps of login account registration (15) the assignment of the e-mail account (16), the data entry for the customer's preferences (17) and the database for the customer (18).

FIG. 3 is a flow diagram showing the organization of the vendor configuration module (11) starting from data entry from the vendor (19), sample purchase by the consumer using the YOURSHORTCUT.COM e-mail account (20), data mapping for vendor's e-mail receipt (21) and the vendor database (22).

FIG. 4 is a flow diagram showing the data extraction module (14) comprising the steps of (scanning all received e-mails (23), selecting known vendor e-mail receipts, copying selected transaction data from the e-mail (25) and transferring said data to the transaction data base (12).

### 5. DETAILED DESCRIPTION OF THE INVENTION

The present invention satisfies the need for creating an online community of consumers and vendors, and a purchasing management system that facilitates purchases by a consumer from a range of vendors to optimize the consumer's purchasing activities based on a range of criteria including, but not limited to pricing, availability or quality.

In accordance with the above, the invention provide a purchasing management system comprising a database of registered consumers and vendors and a transactional database generated from purchase order transaction confirmation emails for purposes of reporting, analyzing and controlling the business process. Registration of consumers and vendors is a requirement for participation in the YOURSHORTCUT.COM business portal.

The present invention provides a method of placing an online order by the consumer at a vendor e-commerce website, obtaining a bargained price and receiving various order status confirmation emails. The transactional data from e-mail confirmations is stored in a transactional database. A software program applied to the transactional database queries the data collected and provides the necessary purchasing management decision, support, reporting and process control.

In another aspect of the present invention the web site YOURSHORTCUT.COM uses the purchasing management system in an online consumer member portal with a business model that leverages low pricing from online vendors. The invention automatically provides email accounts free of charge to registered consumers. But the web site YOURSHORTCUT.COM registers the vendors, to become part of the YOURSHORTCUT.COM business portal.

The invention provides a system comprising a customer master database, a vendor master database and a transactional database for complete Enterprise Resource Planning (ERP) compatibility, thereby providing unlimited access and reporting, analysis, management and process control by customers, vendors, administrators or managers. This system may be applicable to any entity looking to optimize its purchasing activities for a range of criteria such as pricing, availability, or quality. For example, the invention provides the vendors purchasing controls that are driven by the data collected in the transactional database to determine minimum inventory levels, just in time supply, parts and finished goods inventory management. The invention additionally generates automated purchasing systems from the data.

The “Purchasing Management System” of the present invention automatically organizes purchasing transactions by a buyer from multiple vendors into a database for reporting, analysis and business process control. The transactional data is retrieved from email confirmations sent by the vendor to the buyer. The resulting transactional database is queried by a software program to facilitate all necessary purchasing management decision support reporting and process control.

YOURSHORTCUT.COM uses the “Purchasing Management System” of the present invention in an online consumer member portal with a business model that leverages low pricing from online vendors. Registered consumers are automatically provided with free email accounts that must be used for order confirmation. Vendors similarly must register to become part of the YOURSHORTCUT.COM business portal. This level of pre-registration is a prerequisite to participation in the YOURSHORTCUT.COM application of the “Purchasing Management System” of the present invention but is not a prerequisite to the invention itself.

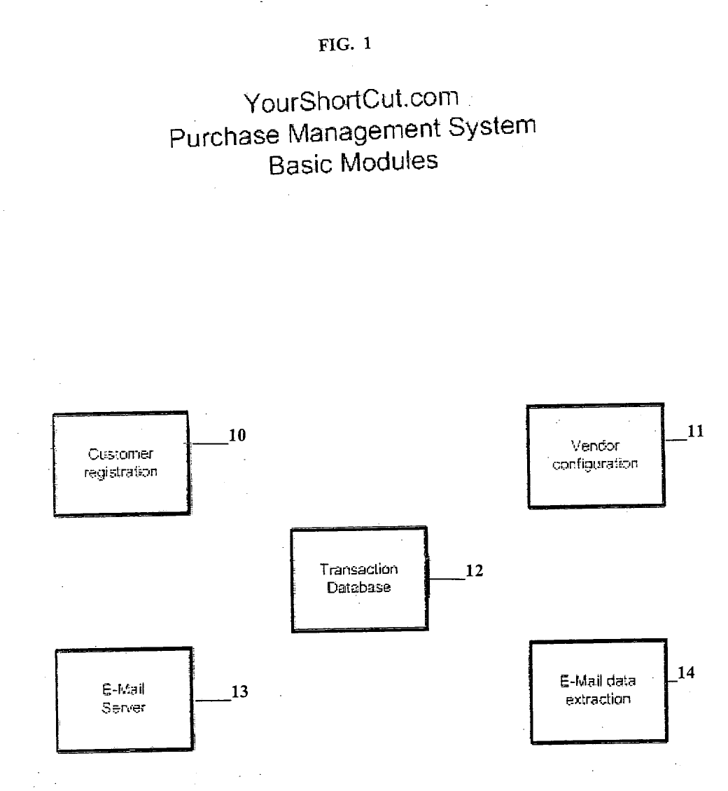

FIG. 1 is a chart that shows the basic modules of the YOURSHORTCUT.COM purchase management system, including the customer registration module (10), the vendor registration module (11), the transaction database module (12), the e-mail server (13) and the e-mail data extraction module (14). This chart describes the minimum functional modules necessary for the Purchasing Management System to operate. These functions can be enabled either manually or through the use of software. The functions can be populated with data either through manual administration or automated processing. The modules accumulate data that build Customer Master and Vendor Master Databases. A separate Transactional Database (12) is structured as part of the Purchasing Management System that could be “mined” to form an “Item Master” database for enhanced business process and automated system management.

Buyer Registration

Login account registration—The buyer registration module records buyer information and provides them with system login credentials. The level of buyer information necessary will depend on the specific application of the “Purchasing Management System” of the present invention and can vary from model to model. In the case of yourshortcut.com, only the customer (buyer) first and last name are required.

Email account assignment—Buyers are assigned an email account that is hosted and managed by the entity using the “Purchasing Management System” of the present invention. This email account must be used when purchasing, as the official transaction confirmation email with the vendor. In the case of Yourshortcut.com the customer is automatically assigned a free unique email account that can be used for any normal email purpose in addition to purchase order confirmation.

Buyer preference data entry—Buyers record their reporting and user interface preferences to enhance usability and business process efficiency. While this is not a strict requirement of the “Purchasing Management System” of the present invention it significantly enhances the user friendliness of any application. In the case of YOURSHORTCUT.COM the preferences enhance and semi-customize the user interface. It also adds to YOURSHORTCUT.COM's knowledge of customer profiles.

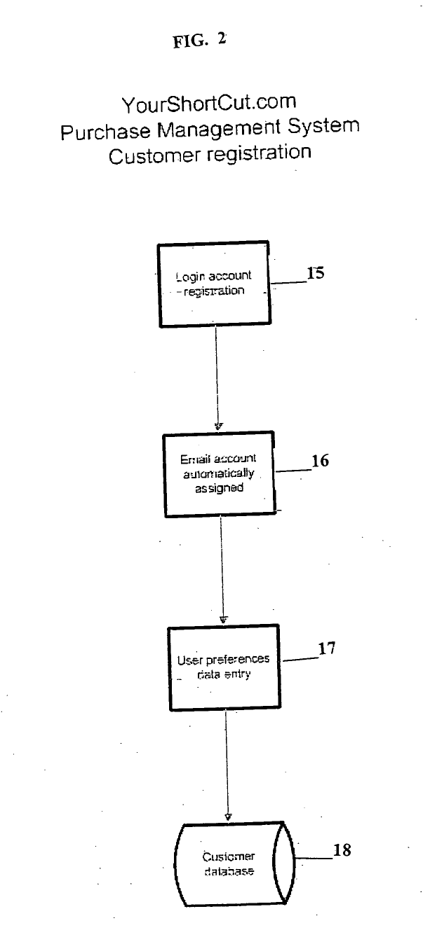

FIG. 2 is a chart that describes the organization of the customer registration module (10) in terms of the steps of login account registration (15) the assignment of the e-mail account (16), the data entry for the customer's preferences (17) and the database for the customer (18). This chart describes the process of registering buyers (15) and assigning necessary an e-mail account (16) and enhanced profile attributes (17). At a minimum the buyer must have a login, and be assigned an email with a domain in the Purchasing Management System. This data constitutes the basis of the “customer master” database (18) that can be enhanced with additional customer profile attributes.

### Vendor Configuration

Vendor contact data entry—Basic vendor contact information is entered to establish a vendor record. The level of vendor information necessary will depend on the specific “purchasing management system” application and can vary from model to model. In the case of Yourshortcut.com the vendor name, address, email, phone and administrator contact are required.

Sample purchase using email account of the “Purchasing Management System” of the present invention—An initial test purchase is made by the YOURSHORTCUT.COM from the vendor to configure the website to vendors” needs.

Data mapping of vendor email confirmation—As the sample purchase is processed by vendor various transaction confirmation emails are sent to the buyer. These emails vary from vendor to vendor and could include 1) Order confirmation 2) Product shipment 3) Payment processing 4) Back order status and various others. Each sample purchase transaction email has its critical data location identified and mapped to the “Purchasing Management System” of the present invention database to create a unique vendor/transaction confirmation data extraction model.

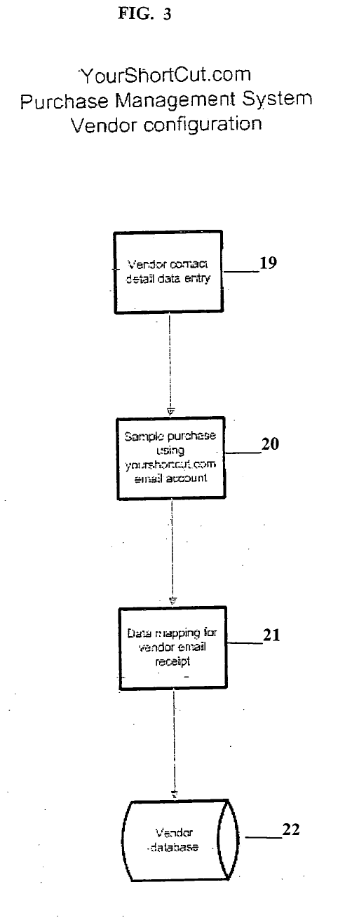

FIG. 3 is a chart showing the organization of the vendor configuration module (11) starting from data entry from the vendor (19), sample purchase by the consumer using the YOURSHORTCUT.COM e-mail account (20), data mapping for vendor's e-mail receipt (21) and the vendor database (22). VENDOR CONFIGURATION. This chart describes the process of registering and configuring vendors (19) to result in a Vendor Master database (22) with known email order transaction (20) confirmation notification formats. When a vendor is identified an initial purchase order is placed in order to drive the receipt of an initial order transaction confirmation notification. When the initial order transaction confirmation notification (21) is received by the Purchasing Management System the subject line text is registered and the body of the text is analyzed. The analysis results in a standard data mapping format for that vendor order transaction confirmation notification that copies known data to the transactional database (12).

Email Data Extraction

Scan all received emails—The “Purchasing Management System” of the present invention scans the subject field of all emails received by registered buyers.

Select known vendor email receipts—The “Purchasing Management System” of the present invention selects known vendor/transaction confirmation emails based on the unique models tagged for data extraction.

Copy selected transactional data from email—The “Purchasing Management System” of the present invention then applies the data extraction model to the email body and records the critical data in the transactional database.

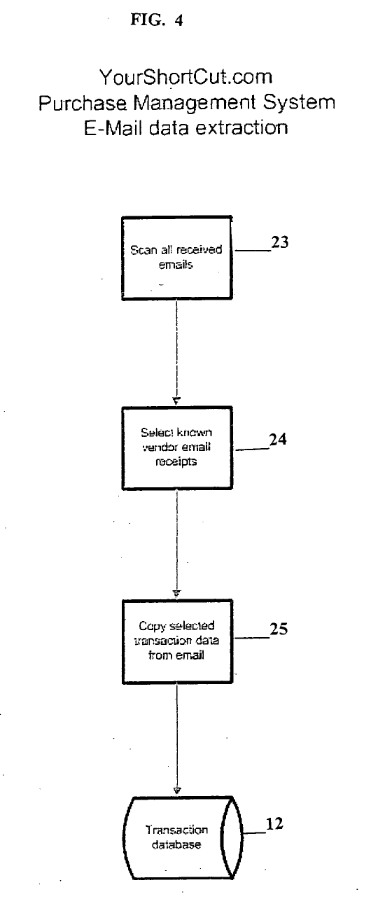

FIG. 4 is a chart showing the data extraction module (14) comprising the steps of (scanning all received e-mails (23), selecting known vendor e-mail receipts, copying selected transaction data from the e-mail (25) and transferring said data to the transaction data base (12). E-MAIL DATA EXTRACTION: This chart describes the process of analyses of data contained in incoming emails (23) with known text in the subject line indicating that it is a vendor order transaction confirmation notification (24). Once a recognized email is detected, the body of the mail is analyzed using the predefined format for that vendor order transaction confirmation notification (25). Key data from the email is then copied to the transactional database 12).

A purchasing management system for use by a community of customers, which system operates in part on an online server, said system comprising: a first module running on the server for registering the customers; a second module running on the server for registering a plurality of vendors desiring to act as suppliers for said customers in the community and said second module being based on a set of marketing criteria such that such data is accessible to the community of consumers; a third module running on the server for receiving email orders from customers, said third module being adapted to place the orders to the vendors, and record an e-mail confirmation of the orders; and a fourth module running on the server permitting said system to extract transactional data from the e-mail orders received and confirmed, copying selected transactional data and transferring to a fifth module, a transactional database of the system. The first module further issues a free of charge e-mail account to the customer for both access to the system and for general communication use. The second module posts special price postings from vendors, including data corresponding to orders previously placed by the consumers. The third module monitors orders from said consumers to generate statistical information regarding purchasing habits of said consumers.

A method of operating a purchasing management system used by a community of consumers, and which system operates in part on an online server, said method comprising the steps of: registering a plurality of customers in the community, registering a plurality of vendors in the community and providing said customers product promotion services, providing an e-mail server for handling order, confirmations of orders filled, and storing data on orders in a transactional data base, so that at least some of the data is accessible t at least some of the community consumers and vendors. The method of the present inventions further comprising the steps of issuing a free e-mail account to the registered customer, monitoring orders from consumers to generate statistical information regarding purchasing habits of said consumers, and posting special prices from vendors.

Tables 1 to 18 show the database specifications that are employed to process performance data in the following categories:
Database Name: YSC
Database User Name: Yourshortcut
Database Password: Success

TABLE 1
APPOINTMENT
Table 1 demonstrates the procedure used to store all appointments
for a vendor.

| Field Name | DataType | Length | Required |
|---|---|---|---|
| APPOINTMENT_ID | int | 4 | 0 |
| START_DATE | datetime | 8 | 1 |
| END_DATE | datetime | 8 | 1 |
| START_TIME | datetime | 8 | 1 |
| END_TIME | datetime | 8 | 1 |
| SUBJECT | varchar | 500 | 1 |
| LOCATION | varchar | 500 | 1 |
| ALL_DAY_EVENT | bit | 1 | 1 |
| APPOINTMENT_MESSAGE | varchar | 4000 | 1 |
| USER_ID | int | 4 | 1 |
| CONTACT_ID | int | 4 | 1 |
| COMPLETED | bit | 1 | 1 |

TABLE 2
BACKGROUND IMAGES
Table 2 provides the procedure to store the background image for the
home page header. Member will be able to select one of these images
in the preference page of their account setup. There is no user interface
for YOURSHORTCUT.COM to upload new images. If they wish to add
images to this table they must contact SHORTCUT.COM and they will
manually ftp the file to the server and add the file path to this table.

| Field Name | DataType | Length | Required |
|---|---|---|---|
| BACKGROUND_ID | int | 4 | 0 |
| IMAGE_LOCATION | varchar | 200 | 1 |

TABLE 3
BIDDING CUTOFF
The purpose of table 3 is to specify the bid date. For example if
December 25^{th}, 2006 is the date being bid for and the
advance days is 7, then the system will subtract 7 days from
December 25^{th}, 2006 and December 18^{th}, 2006 will
be the date in which the vendor will bid for December 25^{th},
2006 advertisement slot. And thus the system will not allow any
new bids for December 25^{th}, 2006 after or before December
18^{th}, 2006, the only day a vendor will be able to bid for
the December 25^{th}, 2006 advertisement slot will be on
December 18^{th}, 2006.

| Field Name | DataType | Length | Required |
|---|---|---|---|
| ADVANCE_DAYS | Int | 4 | 1 |

TABLE 4
BIDS
The purpose of Table 4 is to store all of the bids entered by all vendors.

| Field Name | DataType | Length | Required |
|---|---|---|---|
| BID_ID | int | 4 | 0 |
| CONTACT_ID | int | 4 | 1 |
| DATE_SELECTED | datetime | 8 | 1 |
| BID_AMOUNT | money | 8 | 1 |
| DATE_CREATED | datetime | 8 | 1 |
| DOCUMENT_ID | int | 4 | 1 |

TABLE 5
CATEGORY
The purpose of Table 5 is to specify all of the vendor categories such
as Jewelry, Automobile, Apparel, etc . . . Yourshortcut.com has the
ability to modify this table any time through the Admin section.

| Field Name | DataType | Length | Required |
|---|---|---|---|
| CATEGORY_ID | int | 4 | 0 |
| CATEGORY_NAME | varchar | 75 | 1 |

TABLE 6
COLORS
This is a System Table: The purpose of Table 6 is to store all of
the colors that a member will be able to choose from within their
preference page. The colors they select will be added to their
preferences and will be reflected on their custom home page.

| Field Name | DataType | Length | Required |
|---|---|---|---|
| COLOR | varchar | 50 | 0 |
| COLOR_VALUE | varchar | 50 | 1 |

TABLE 7
CONTACTS
Table 7 keeps tract of all contact information for all vendors and members.

| Field Name | DataType | Length | Required |
|---|---|---|---|
| CONTACT_ID | Int | 4 | 0 |
| CONTACT_CODE | Varchar | 20 | 1 |
| CONTACT_NAME | Varchar | 150 | 1 |
| FIRST_NAME | Varchar | 50 | 1 |
| MIDDLE_INITIAL | Varchar | 1 | 1 |
| LAST_NAME | Varchar | 50 | 1 |
| COMPANY_NAME | varchar | 150 | 1 |
| USER_NAME | varchar | 50 | 1 |
| PASSWORD | varchar | 50 | 1 |
| BILL_ADDRESS_1 | varchar | 75 | 1 |
| BILL_ADDRESS_2 | varchar | 75 | 1 |
| BILL_CITY | varchar | 50 | 1 |
| BILL_STATE | varchar | 2 | 1 |
| BILL_ZIP | varchar | 10 | 1 |
| BILL_PROVINCE | varchar | 50 | 1 |
| BILL_COUNTRY | varchar | 50 | 1 |
| TAX_ID | varchar | 50 | 1 |
| PHONE | varchar | 12 | 1 |
| WORK_PHONE | varchar | 12 | 1 |
| FAX | varchar | 12 | 1 |
| CELL | varchar | 12 | 1 |
| E_MAIL | varchar | 75 | 1 |
| WEB_SITE | varchar | 200 | 1 |
| CREATED_BY | int | 4 | 1 |
| DATE_CREATED | datetime | 8 | 1 |
| MODIFIED_BY | int | 4 | 1 |
| DATE_MODIFIED | datetime | 8 | 1 |
| VENDOR | bit | 1 | 1 |
| CUSTOMER | bit | 1 | 1 |
| LONGITUDE | varchar | 50 | 1 |
| LATITUDE | varchar | 50 | 1 |
| CATEGORY_ID | int | 4 | 1 |
| DATE_OF_BIRTH | varchar | 7 | 1 |
| WEDDING_ANNIVERSARY | varchar | 7 | 1 |
| COLOR_PAGE_HEADER | varchar | 20 | 1 |
| COLOR_PAGE_HEADER_BACKGROUND | varchar | 200 | 1 |
| USE_IMAGE | bit | 1 | 1 |
| COLOR_PAGE_HEADER_TEXT | varchar | 20 | 1 |
| COLOR_SECTION_HEADER | varchar | 20 | 1 |
| COLOR_SECTION_BORDER | varchar | 20 | 1 |
| COLOR_SECTION_HEADER_TEXT | varchar | 20 | 1 |
| COLOR_TOP_BAR | varchar | 20 | 1 |
| COLOR_TOP_BAR_TEXT | varchar | 20 | 1 |
| COLOR_BOTTOM_BAR | varchar | 20 | 1 |
| COLOR_BOTTOM_BAR_TEXT | varchar | 20 | 1 |

TABLE 8
DOCUMENTS
Table 8 shows how to store all of the ads uploaded by all vendors.

| Field Name | DataType | Length | Required |
|---|---|---|---|
| DOCUMENT_ID | int | 4 | 0 |
| ENTITY_TYPE | varchar | 15 | 1 |
| DOCUMENT_NAME | varchar | 150 | 1 |
| DESCRIPTION | varchar | 250 | 1 |
| CONTACT_ID | int | 4 | 1 |
| DATE_CREATED | datetime | 8 | 1 |
| CREATED_BY | int | 4 | 1 |
| DATE_MODIFIED | datetime | 8 | 1 |
| MODIFIED_BY | int | 4 | 1 |
| PHOTO_ORDER | decimal | 9 | 1 |
| DOCUMENT_CATEGORY_ID | int | 4 | 1 |
| FILE_EXIST | bit | 1 | 1 |
| DOCUMENT_TITLE | varchar | 200 | 1 |
| DOCUMENT_AUTHOR | varchar | 200 | 1 |
| APPROVED | bit | 1 | 1 |
| LOGO | bit | 1 | 1 |

TABLE 9
ORDER DETAILS
Table 9 shows how to keep track of all detailed information
pertaining to an order. The header information for
the order is stored in Table 10 (below).

| Field Name | DataType | Length | Required |
|---|---|---|---|
| DETAIL_ID | Int | 4 | 0 |
| ORDER_ID | Int | 4 | 1 |
| PRODUCT | Varchar | 100 | 1 |
| DESCRIPTION | Varchar | 200 | 1 |
| QTY | Numeric | 9 | 1 |
| ORDER_NUM | Varchar | 100 | 1 |
| UNIT_AMOUNT | Money | 8 | 1 |
| TAX | Money | 8 | 1 |
| LINE_AMOUNT | Money | 8 | 1 |

TABLE 10
ORDER HEADER
Table 10 shows how to keep track of the header information of an
order such as customer name, vendor, order #, and Total Amount.
The detailed line items for an order is stored in the Table 9.

| Field Name | DataType | Length | Required |
|---|---|---|---|
| ORDER_ID | int | 4 | 0 |
| ORDER_DATE | datetime | 8 | 1 |
| VENDOR_ID | int | 4 | 1 |
| CONTACT_ID | int | 4 | 1 |
| ORDER_NUM | varchar | 100 | 1 |
| SHIPPING | money | 8 | 1 |
| TAXES | money | 8 | 1 |
| TOTAL_AMOUNT | money | 8 | 1 |

TABLE 11
SALES
Table 11 shows to store all of the sales being offered by a vendor.

| Field Name | DataType | Length | Required |
|---|---|---|---|
| SALES_ID | int | 4 | 0 |
| SALES_DATE | datetime | 8 | 1 |
| CONTACT_ID | int | 4 | 1 |
| TITLE | varchar | 400 | 1 |
| NOTES | varchar | 4000 | 1 |
| DOCUMENT_ID | int | 4 | 1 |

TABLE 12
SLOT HOUR
System Table 12 keeps track of the hours within a day,
it is a system table that supports the Table 1.

| Field Name | DataType | Length | Required |
|---|---|---|---|
| HOUR_ID | Int | 4 | 0 |
| SLOT_HOUR | varchar | 50 | 1 |

TABLE 13
SLOT SECTIONS
System Table 13 shows how to keep track of the minutes within
an hour. It is a system table that supports the Table 1.

| Field Name | DataType | Length | Required |
|---|---|---|---|
| SLOT_ID | Decimal | 9 | 0 |
| HOUR_ID | Int | 4 | 1 |
| SLOT_SECTION | Varchar | 50 | 1 |
| MINUTES | Decimal | 9 | 1 |

TABLE 14
STATE
System Table 14 keeps track of all of the states within the
United States. This table supports the Table 7

| Field Name | DataType | Length | Required |
|---|---|---|---|
| STATE | varchar | 2 | 0 |
| STATE_DESC | varchar | 75 | 1 |

TABLE 15
SYSTEM COUNTERS
System Table 15 keeps track of site visits. It supports the
counter display on the yourshortcut.com home page.

| Field Name | DataType | Length | Required |
|---|---|---|---|
| COUNTER_ID | int | 4 | 0 |
| COUNTER_TYPE | varchar | 50 | 1 |
| COUNTER_VALUE | numeric | 17 | 1 |

TABLE 16
SYSTEM GROUP ACCESS
Table 16 keeps track of all of the favorite selections made by the
member. If the member selected five sites from their favorites
then this table will store those five sites. When they log into
the system they will only see these five records within
their favorites drop down field.

| Field Name | DataType | Length | Required |
|---|---|---|---|
| SYSTEM_ACCESS_ID | Int | 4 | 0 |
| SYSTEM_GROUP_ID | Int | 4 | 1 |
| SECTION_ID | Int | 4 | 1 |
| SECTION_NAME | Varchar | 75 | 1 |
| RIGHTS | Nvarchar | 10 | 1 |

TABLE 17
SYSTEM SCREENS
Table 17 keeps track of all of the sites
that a user can select as a favorite.

| Field Name | DataType | Length | Required |
|---|---|---|---|
| SECTION_ID | int | 4 | 0 |
| SECTION_NAME | varchar | 50 | 1 |
| LABEL | Varchar | 75 | 1 |
| LABEL_ORDER | numeric | 9 | 1 |
| PARENT_SECTION_ID | Int | 4 | 1 |
| OMIT | Bit | 1 | 1 |

TABLE 18
WINNING BIDS
Table 18 keeps track of all winning bids.
It is populated by a stored procedure named
“YSCSP_000_Update_Winning_Bids”

| Field Name | DataType | Length | Required |
|---|---|---|---|
| ID | int | 4 | 0 |
| CONTACT_ID | int | 4 | 1 |
| DOCUMENT_ID | int | 4 | 1 |
| DATE_SELECTED | datetime | 8 | 1 |
| BID_AMOUNT | money | 8 | 1 |
| DATE_OF_BID | datetime | 8 | 1 |

The present invention is not to be limited in scope by the embodiment disclosed in the example which is intended as an illustration of one aspect of the invention and any methods which are functionally equivalent are within the scope of the invention. Indeed, various modifications of the invention in addition to those shown and described herein will become apparent to those skilled in the art from the foregoing description. Such modifications are intended to fall within the scope of the appended claims.

Those skilled in the art will recognize, or be able to ascertain using no more than routine experimentation, any equivalents to the specific embodiments of the invention described herein. Such equivalents are intended to be encompassed by the claims. For example, it is apparent that the present invention would be useful to any entity or in any environment where it is useful to optimize the purchasing activities for a range of criteria comprising pricing, availability or quality. Other implementations of the Purchasing Management System beyond those illustrated in the foregoing detailed description can be used suitably with the present invention. Accordingly, it is intended that all such alterations and modifications be included within the scope and spirit of the invention as defined by the following claims.

What is claimed is:

1. A purchasing management system for use by a community of customers, which system operates in part on an online server, said system comprising:
a) a first module running on the server for registering the customers;
b) a second module running on the server for registering a plurality of vendors desiring to act as suppliers for said customers in the community; and
c) a third module running on the server for receiving email orders from customers, said third module being adapted to record e-mail confirmations of orders placed by the consumer from the vendor.

2. The system according to claim 1 further comprising a fourth module running on the server permitting said system to extract transactional data from the e-mail orders received and confirmed, copying selected transactional data and transferring to a fifth module, a transactional database of the system.

3. The system according to claim 1 wherein the third module monitors orders from said consumers to generate statistical information regarding purchasing habits of said consumers.

4. The system according to claim 1, wherein the second module posts special price postings from vendors, including data corresponding to orders previously placed by the consumers.

5. The system according to claim 2 wherein the third module monitors orders from said consumers to generate statistical information regarding purchasing habits of said consumers.

6. The system according to claim 2, wherein the second module posts special price postings from vendors, including data corresponding to orders previously placed by the consumers.

7. A method of operating a purchasing management system used by a community of consumers, and which system operates in part on an online server, said method comprising the steps of:
a) registering a plurality of customers in the community,
b) registering a plurality of vendors in the community and providing said customers product promotion services,
c) providing an e-mail server for handling orders and confirmations of orders filled.

8. The method according to claim 7 further comprising the step of storing data on orders in a transactional data base, so that at least some of the data is accessible t at least some of the community consumers and vendors.

9. The method according to claim 7, further comprising the step of issuing a free e-mail account to the customer registered in step a).

10. The method according to claim 7 further comprising step e): monitoring orders from consumers to generate statistical information regarding purchasing habits of said consumers.

11. The method according to claim 7 further comprising step f): posting special prices from vendors.

12. The method according to claim 8 further comprising the step of issuing a free e-mail account to the customer registered in step a).

13. The method according to claim 8 further comprising step e): monitoring orders from consumers to generate statistical information regarding purchasing habits of said consumers.

14. The method according to claim 8 further comprising step f): posting special prices from vendors.
